(19) United States
(12) Patent Application Publication
(10) Pub. No.: US 2009/0290239 A1
(43) Pub. Date: Nov. 26, 2009

(54) LENS MODULE

(75) Inventor: Cheng-Shiun Wu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/342,207

(22) Filed: Dec. 23, 2008

(30) Foreign Application Priority Data
May 21, 2008 (CN) 200810301687.7

(51) Int. Cl. G02B 7/02

(52) U.S. Cl. 359/819

(57) ABSTRACT

An exemplary lens module includes a barrel, a lens received in the barrel, and a ring-shaped fastening member. The barrel includes a supporting portion at a first end thereof and an internal thread formed at an opposite second end. The ring-shaped fastening member includes a side surface and an external thread formed on the side surface. The ring-shaped fastening member is received in the barrel and threadedly engaged with the barrel such that the lens is tightly fixed between the supporting portion of the barrel and the ring-shaped fastening member.

### TECHNICAL FIELD

The present invention relates to imaging technology, and particularly to a lens module.

### DESCRIPTION OF RELATED ART

A typical lens module 20 is shown in FIG. 3. The lens module 20 includes a barrel 202 and a plurality of optical elements received in the barrel 202. The optical elements includes a first lens 204, a light blocking plate 210, a second lens 206, a spacer 212 and a third lens 208. The lens module 20 has an optical axis. The barrel 202 includes a supporting portion 2022. Generally, the optical elements are mounted in the barrel 202 via an adhesive.

However, when the optical elements are not well fixed in the barrel 202, or the adhering strength of the adhesive deteriorates, the structure of the lens module 20 may be prone to unstable. Referring to FIG. 4, when the lens module 20 is heated, the optical elements may expand. Because the first lens 204 is in contact with the supporting portion 2022 of the barrel 202, the optical elements may expand along the optical axis 214 in a direction away from the supporting portion 2022. As a result, the imaging quality of the lens module 20 is weakened.

Therefore, a new lens module is desired to overcome the above mentioned problems.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a side, cross-sectional view of a lens module according to an exemplary embodiment.

FIG. 2 is a cross-sectional view of a fastening member of the lens module depicted in FIG. 1.

FIG. 3 is a side, cross-sectional view of a typical lens module.

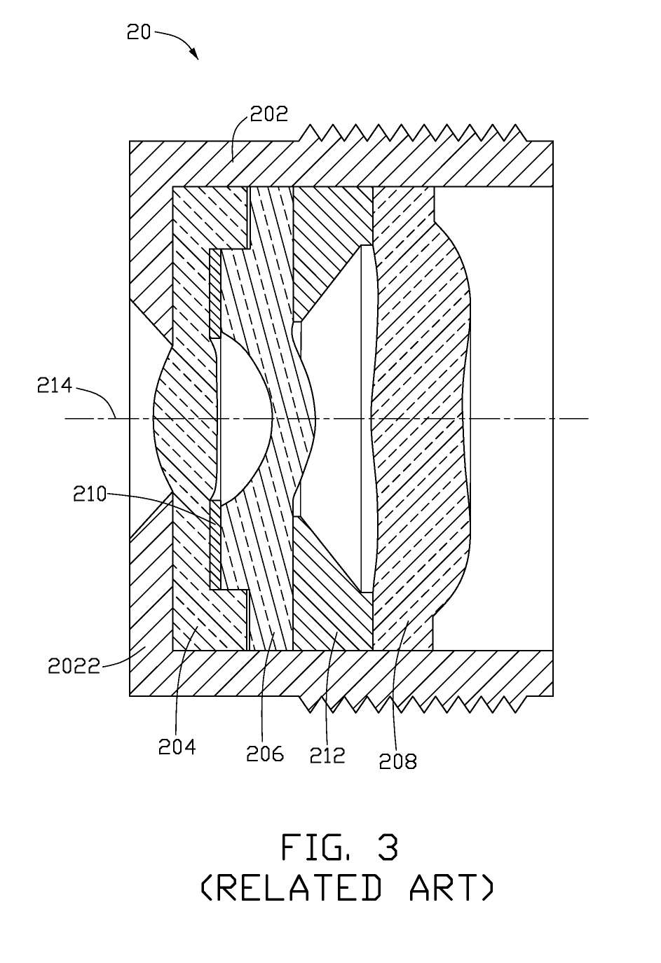

FIG. 4 is a side, cross-sectional view of the lens module when optical elements are heated and expand.

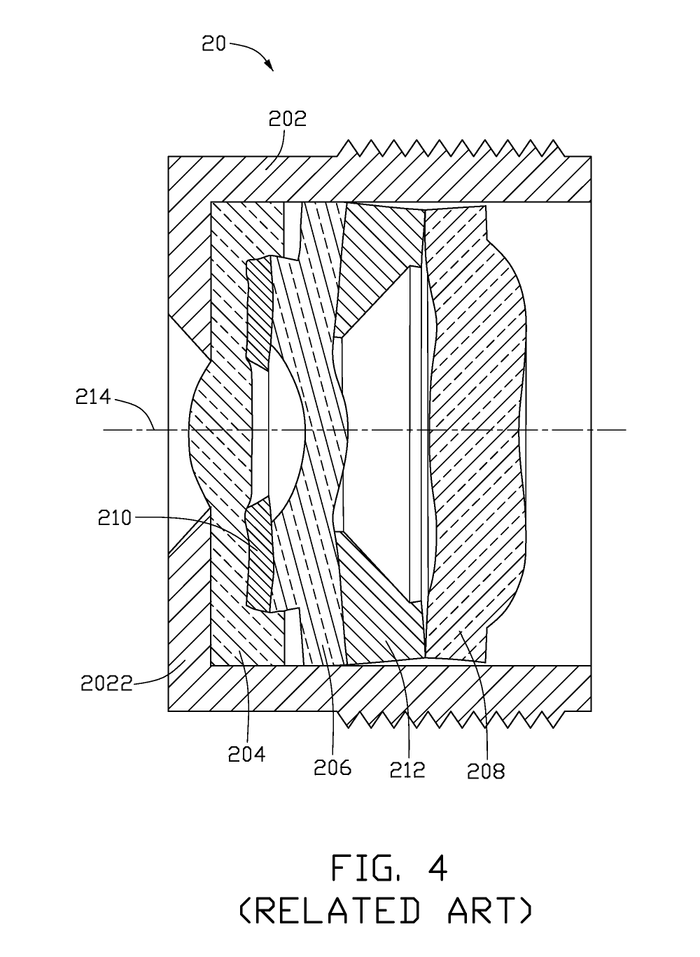

### DETAILED DESCRIPTION OF THE EMBODIMENTS

Embodiments will now be described in detail below with reference to the drawings.

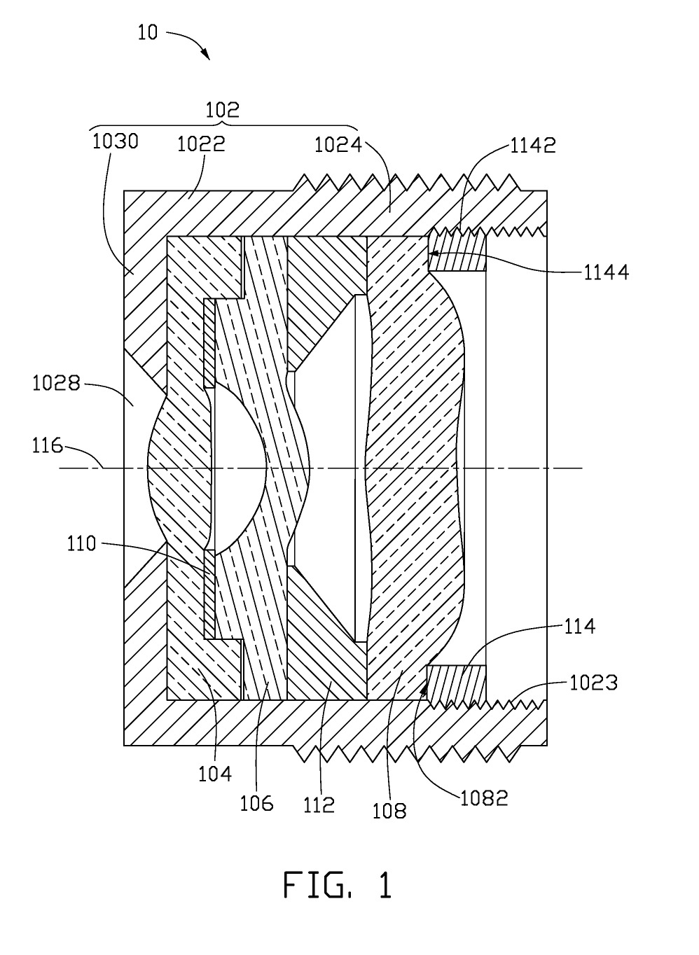

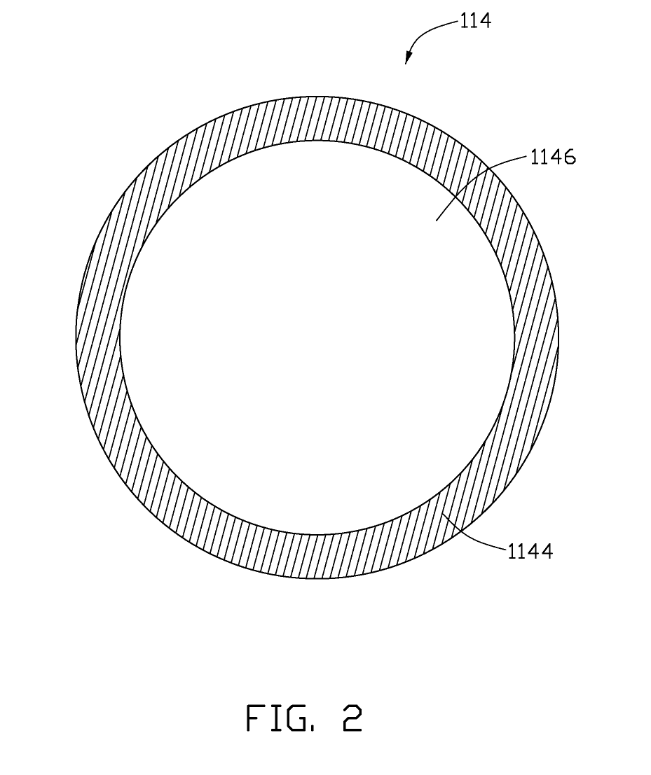

Referring to FIGS. 1-2, a lens module 10 according to an exemplary embodiment includes a barrel 102, a first lens 104, a light blocking plate 110, a second lens 106, a spacer 112, a third lens 108 and a fastening member 114. The first lens 104, the light blocking plate 110, the second lens 106, the spacer 112, the third lens 108 and the fastening member 114 are received in the barrel 102 in an order from an object side to an image side. The lens module 10 defines an optical axis 116.

The barrel 102 includes a cylindrical wall (not labeled) and a supporting portion 1030 formed on an inner surface of the cylindrical wall. The cylindrical wall includes a first end 1022 and an opposite second end 1024. The supporting portion 1030 defines a through hole 1028 at a central portion. The second end 1024 has an internal thread 1023 and an external thread (not labeled) respectively formed at opposite sides of the barrel 102. The external thread is configured for coupling to a holder (not shown). The first lens 104 is in contact with the supporting portion 1030.

The fastening member 114 is ring-shaped. The fastening member 114 includes a side surface (not labeled), a through hole 1146, a top surface 1144, and an external thread 1142 formed on the side surface. The external thread 1142 of the fastening member 114 is configured for engaging with the internal thread 1023 of the barrel 102. The top surface 1144 of the fastening member 114 is in contact with a surface 1082 of the third lens 108. The fastening member 114 can be made of metal, particularly, metal with high hardness.

The fastening member 114 is threadedly coupled to the barrel 102. The fastening member 114 applies a force on the third lens in a direction toward the supporting portion 1030. Hence, the fastening member 114 and supporting portion of the barrel 102 cooperatively define a chamber with a substantially stable volume. Accordingly, when the lens module 10 is heated, the fastening member 114 can reduce or eliminate the expansion of the optical elements along the optical axis 116. Accordingly, the structure of the lens module 10 is more stable, and the imaging quality of the lens module 10 is stable.

A method for assembling the lens module 10 is provided.

Firstly, the first lens 104, the light blocking plate 110, the second lens 106, the spacer 112, and the third lens 108 are sequentially assembled into the barrel 102 in such manner that the first lens 104 is in contact with the supporting portion 1030 of the barrel 102.

Secondly, an adhesive (not shown) is applied between a side surface (not labeled) of the third lens 108 and the barrel 102.

Lastly, the fastening member 114 is threadedly coupled to the barrel via the external thread 1142 of the fastening member 114 and the internal thread 1023 of the barrel 102. In this way, the first lens 104, the light blocking plate 110, the second lens 106, the spacer 112, the third lens 108 are cooperatively sandwiched between the fastening member 114 and the supporting portion 1030 of the barrel 102.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

1. A lens module comprising:
a barrel comprising a supporting portion at a first end thereof, an internal thread formed at an opposite second end thereof, and an external thread formed on the second end thereof;
a lens received in the barrel; and
a ring-shaped fastening member comprising a side surface and an external thread formed on the side surface, the ring-shaped fastening member being received in the barrel and threadedly engaged with the barrel such that the lens is tightly fixed between the supporting portion of the barrel and the ring-shaped fastening member.

2. The lens module of claim 1, wherein the fastening member is made of metal.

3. The lens module of claim 1, wherein the supporting portion defines a through hole therein.

4. (canceled)

5. A lens module comprising:
a barrel comprising a cylindrical wall, a supporting portion formed on an inner surface of the cylindrical wall, and an inner thread defined in the inner surface;
a lens received in the barrel; and
a ring-shaped fastening member disposed in the cylindrical wall at an opposite side of the lens to the supporting portion, the fastening member made of metal and comprising an external thread threadedly engaged with the inner thread of the barrel in a manner that the ring-shaped fastening member applies a force on the lens in a direction toward the supporting portion.

6. A lens module comprising:
a barrel comprising a supporting portion at a first end thereof and an internal thread formed at an opposite second end;
a lens received in the barrel; and
a ring-shaped fastening member made of metal and comprising a side surface and an external thread formed on the side surface, the ring-shaped fastening member being received in the barrel and threadedly engaged with the barrel such that the lens is tightly fixed between the supporting portion of the barrel and the ring-shaped fastening member.
